(19) United States
(12) Patent Application Publication
(10) Pub. No.: US 2023/0043241 A1
(43) Pub. Date: Feb. 9, 2023

(54) HVAC MODULAR UNIFORM DUCT SYSTEM AND METHOD OF USE

(71) Applicant: Henderson Engineers, inc., Lenexa, KS (US)

(72) Inventor: Dustin Schafer, Leawood, KS (US)

(21) Appl. No.: 17/684,812

(22) Filed: Mar. 2, 2022

Related U.S. Application Data
(63) Continuation-in-part of application No. 17/394,042, filed on Aug. 4, 2021.

(51) Int. Cl. F24F 13/02; F16L 43/00

(52) U.S. Cl. CPC F24F 13/0245; F16L 43/00

(57) ABSTRACT

A heating, ventilation, and air-conditioning (HVAC) duct system which includes, at least in part, one or more modular, uniform, pre-manufactured duct elbow elements having two faces of two sizes. Each elbow provides a twenty-two and a half degree (22.5°) bend in a duct system. When combined, the elbow sections can provide forty-five (45°) degree bends or ninety (90°) degree bends, or even offsets within a duct system. Due to the size and shape of the elbows, multiple elbows can be nested within one another for easy packing and shipping.

### CROSS-REFERENCE TO RELATED APPLICATION

This application claims priority in and is a continuation-in-part of U.S. patent application Ser. No. 17/394,042 Filed Aug. 4, 2021, which is incorporated herein by reference.

### BACKGROUND OF THE INVENTION

### 1. Field of the Invention

The present invention relates generally to a heating, air-conditioning, and ventilation (HVAC) duct element and method for use thereof, and more specifically to a modular, uniform HVAC elbow duct element for use in HVAC systems.

### 2. Description of the Related Art

Typically, when designing an HVAC duct system, engineers must carefully calculate the size and position of duct work for optimal air flow through the system. This design is based upon the need for air to reach all areas of a building. However, many times such design is over-engineered and unnecessary, where a standard and uniform modular HVA duct system would provide adequate airflow without requiring different sized ductworks and size-engineering thereof.

These issues are expounded when discussing HVAC duct elbow elements. Typically, either a mitered elbow or a radiused elbow is used. However, both of these options have their drawbacks, and they are extremely difficult to pack and ship and they tend to take up a lot of space. These elements are usually built off-site, rather than typical straight duct pieces which can be manufactured on-site.

Heretofore there has not been available a system or method for an HVAC elbow duct system with the advantages and features of the present invention.

### BRIEF SUMMARY OF THE INVENTION

The present invention generally provides a heating, ventilation, and air- conditioning (HVAC) duct system which includes, at least in part, one or more modular, uniform, pre-manufactured duct elements having a uniform takeoff on one or more sides for connecting to a run to be connected to an air diffuser at the end. Each of the modular duct elements may include a built-in hanger support element so that the engineer merely has to design a very simple modular run of duct elements without unnecessary computations requiring different duct sizes. It also makes it simple and uniform for installing on site.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of an HVAC duct element of a preferred embodiment of the present invention.

FIG. 2 is a top plan view thereof.

FIG. 3 is a side elevational view thereof.

FIG. 4 is a front elevational view thereof.

FIG. 5 is a top plan view of a preferred embodiment of the present invention as it would be used in a typical environment.

FIG. 6 is a three-dimensional isometric view of an alternative embodiment HVAC elbow duct element.

FIG. 7 is a three-dimensional view thereof, showing four HVAC elbow duct elements of FIG. 6 forming a 90-degree elbow section.

FIG. 8 is a three-dimensional view thereof, shown interfaced with straight duct elements.

FIG. 9 is a three-dimensional view of the embodiment of FIG. 6 shown in a nested orientation with multiple embodiments thereof.

FIG. 10 is a top plan view of a system incorporating the embodiment of FIG. 1 and the embodiment of FIG. 6 forming a 90-degree turn.

FIG. 11 is a top plan view of a system incorporating the embodiment of FIG. 1 and the embodiment of FIG. 6 forming a 45-degree turn.

FIG. 12 is a top plan view of a system incorporating the embodiment of FIG. 1 and the embodiment of FIG. 6 forming an offset.

### DETAILED DESCRIPTION OF THE PREFERRED EMBODIMENTS

I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

II. Preferred Embodiment Uniform Modular HVAC Duct System 2

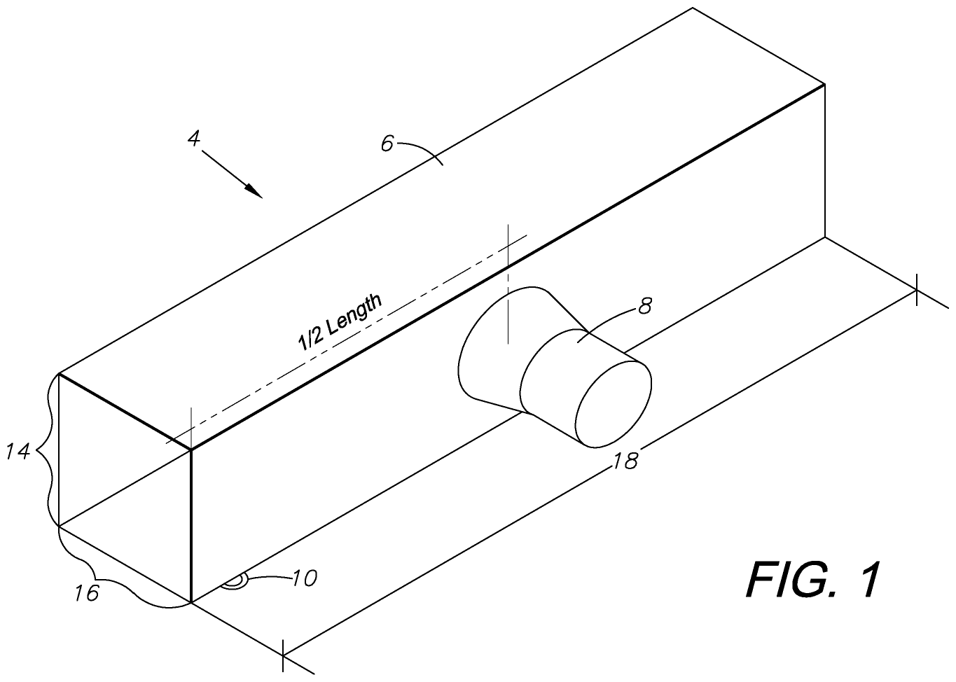

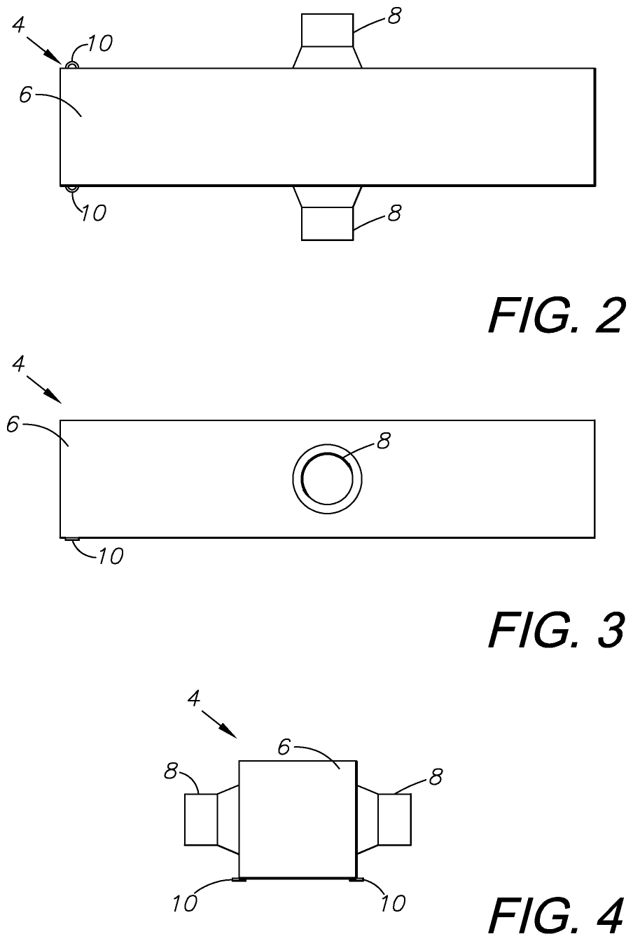

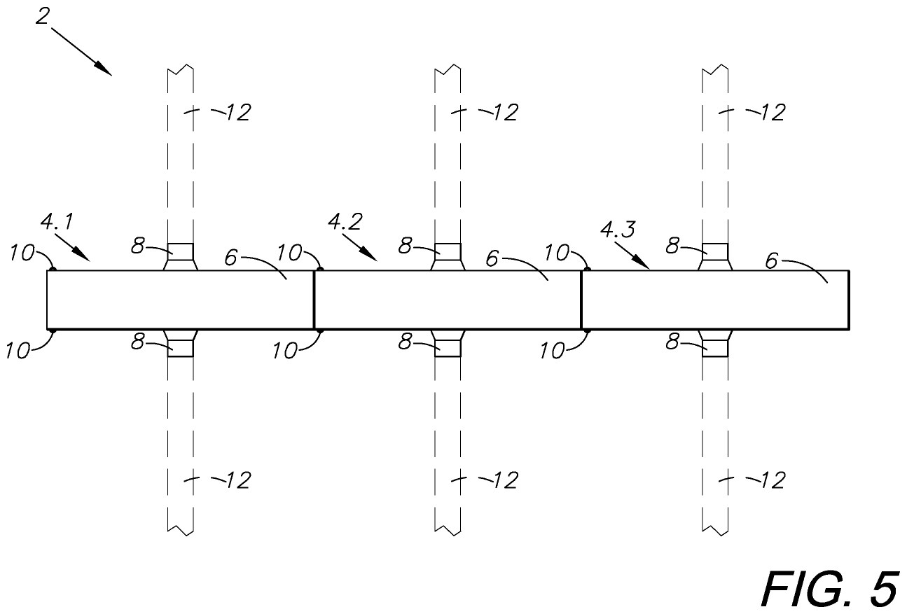

FIGS. 1-4 show a single modular HVAC duct element 4 which includes a uniform, pre-manufactured piece of ductwork 6 with at least one takeoff 8 located uniformly on each of such duct elements 4. These duct elements 4 can be connected together as shown in FIG. 5 to form an entire HVAC duct system 2 wherein each of several such duct elements 4.1, 4.2, 4.3 are joined together to create a duct network. Each duct element 4.1, 4.2, 4.3 are uniform and identical, with the same takeoff 8 numbers and locations. A hanger element 10 can be built into each of the duct elements 4 to help hang the duct in a uniform manner

As shown in FIG. 1, in a preferred embodiment the height 14 and width 16 would be uniform and the length 18 would be as well from one duct element 4 to the next, e.g. 4.1, 4.2, 4.3. The takeoff 8 is shown in the direct center of the length of the element.

As shown in FIG. 5, multiple of the duct elements 4.1, 4.2, 4.3 are shown joined together. Each respective takeoff 8 is shown connected to a run 12 out to the diffuser or other device. These runs 12 may be made with ridged duct or flexible duct or any other suitable duct.

III. Alternative Embodiment Uniform Modular HVCA Duct Elbow System 102

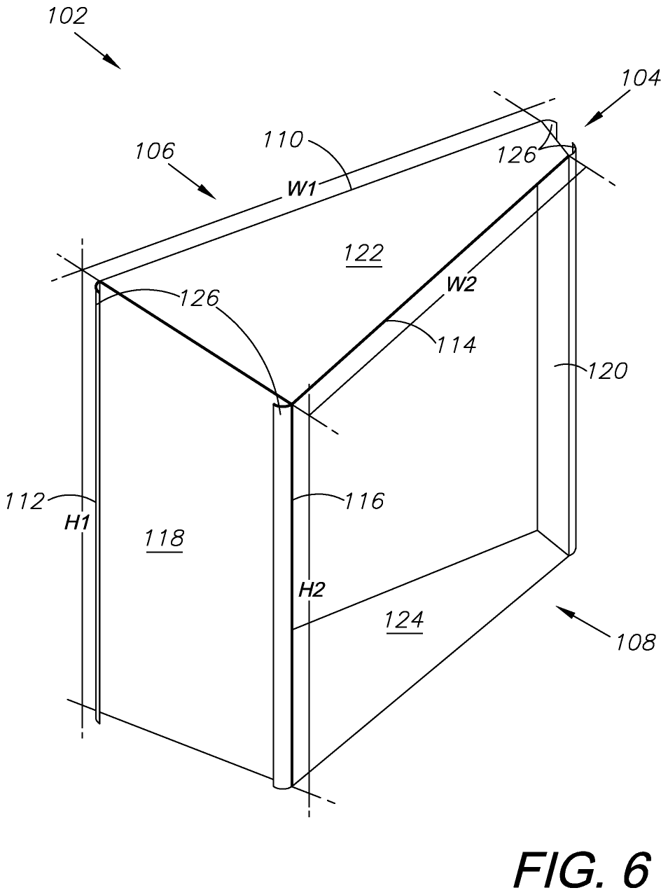

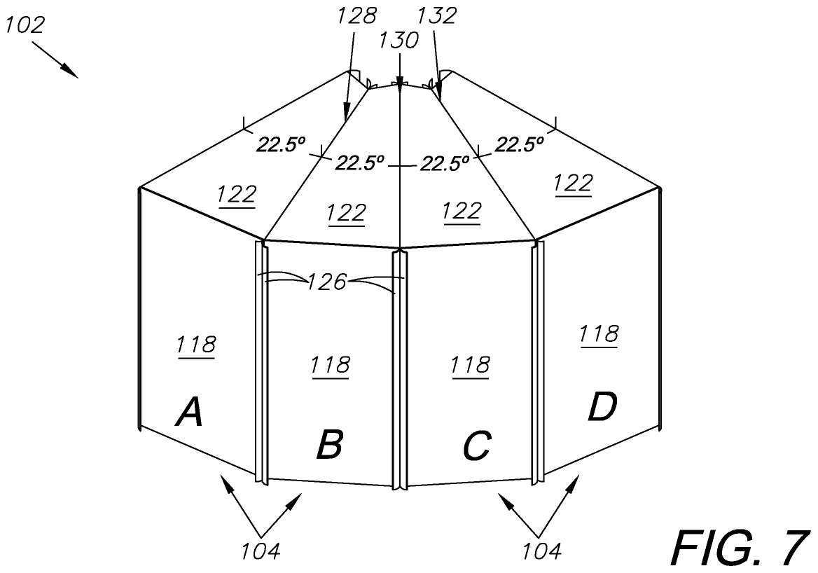

As shown in FIGS. 6-12, an alternative embodiment of the present invention includes a uniform, modular HVAC duct elbow 104 which forms a 22.5-degree angle. The elbow 104 has a first face 106 which has a first width W1 which corresponds to the first face top and bottom edges 110, and a first heigh H1, which correspond with first face side edges 112. The elbow 104 has a second face 108 which has a second width W2 which corresponds to the top and bottom edges 114 of the second face, and a second height H2 which corresponds to the second face side edges 116. In an exemplary embodiment, H1 and W1 are both 16″, and H2 and W2 are both 15″. H2 and W2 can be larger or smaller than the respective H1 and W1, but not the same.

Drive slots 126 are shown along the side faces 118, 120 of the elbow 104. The top 122 and bottom 124 could also have drive slots instead or in addition to the drive slots 126 as shown.

FIG. 7 shows how four elbows 104, labeled A, B, C, and D, can be joined together to form a 90-degree elbow. The first connection 128 between A and B is formed along the smaller sized face 108 in this example, with width W2 and heigh H2. The second connection 130 between B and C is matched with the larger face 106 in this example, with width W1 and height H1. The third connection 132 is similarly matching the smaller faces 108, as with the first connection 128.

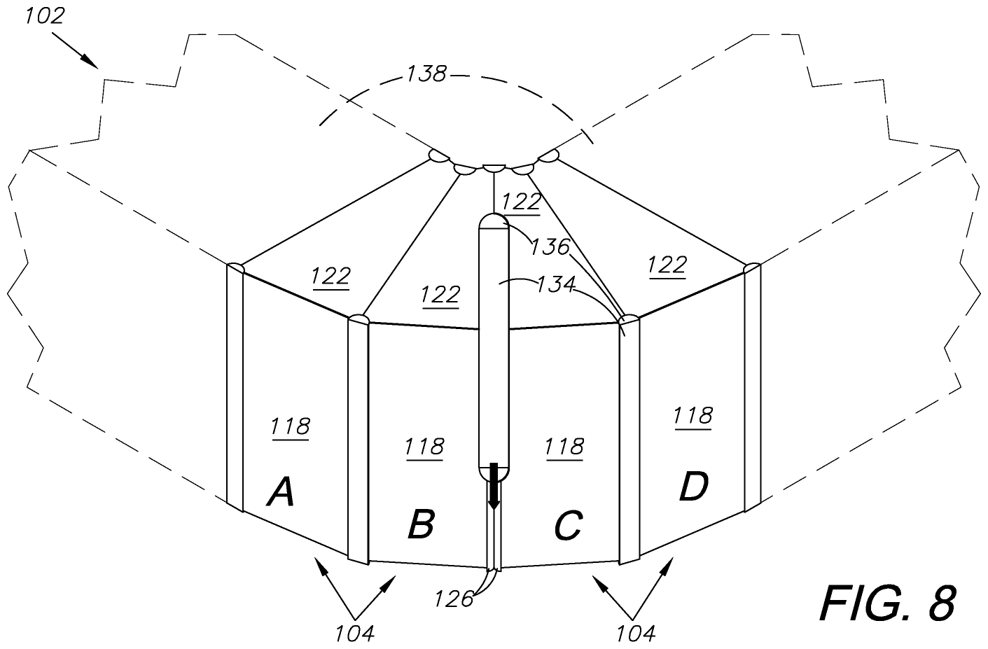

FIG. 8 shows how the embodiment in FIG. 7 is connected to a pair of duct pieces 138 which form the rest of the ventilation duct system. Drives 134 with optional drive tabs 136 are shown joining the elbows 104 A, B, C, and D together and with the adjoining duct elements 138 about the drive slots 126.

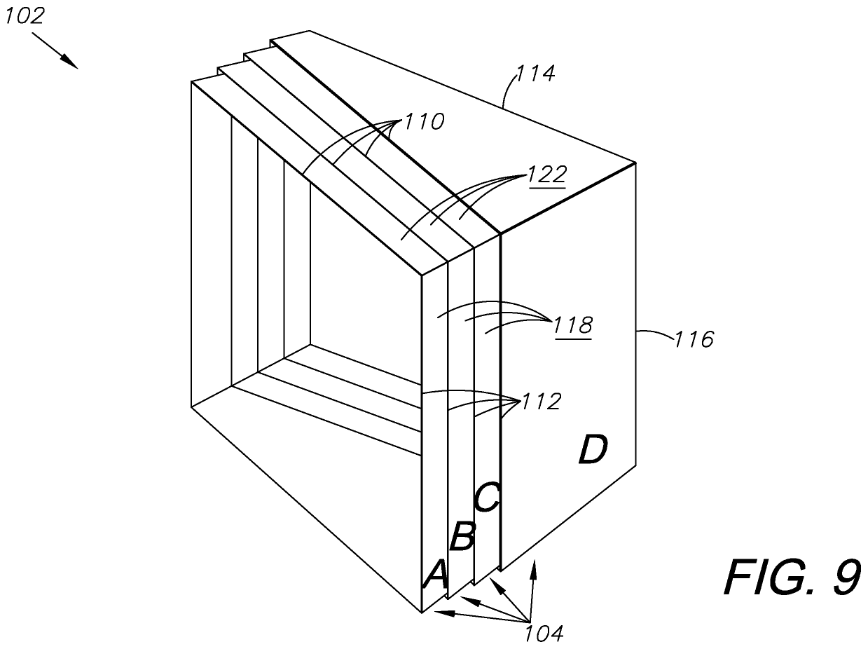

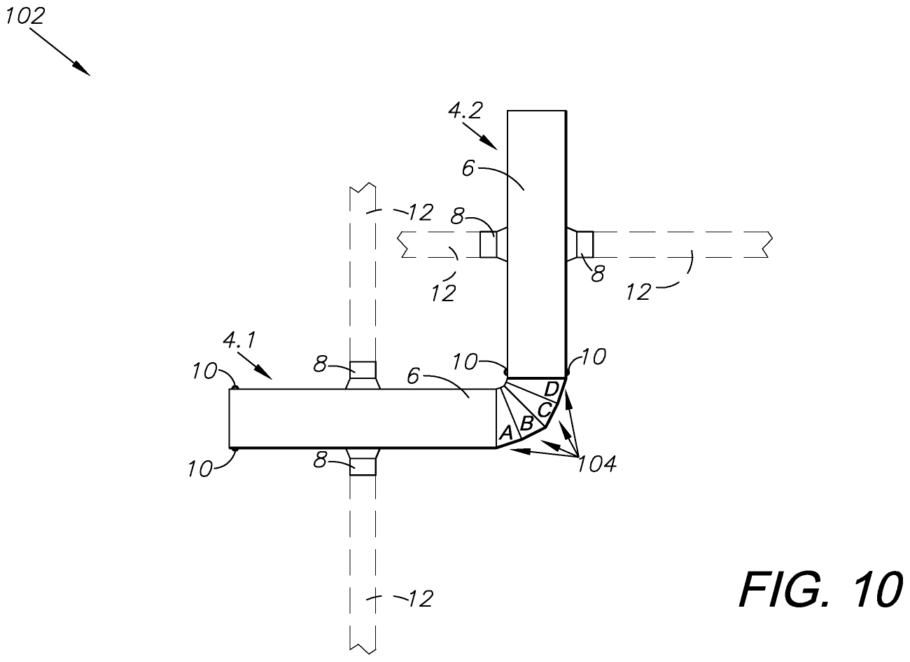

FIG. 9 shows how the four elbows 104 A, B, C, and D can be nested together for easy packing and shipping, which is a major drawback to existing elbows.

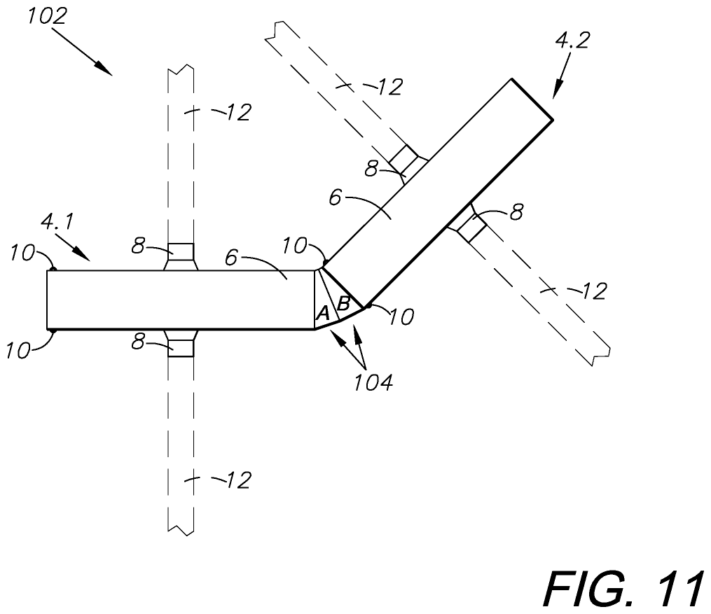

FIG. 10 shows the elbow system 102 with four elbow 104 elements A, B, C, and D joining two of the duct elements 4.1, 4.2 of the previous embodiment system 2. In this figure, the four elbows 104 and the two duct elements 4.1, 4.2 form a 90-degree turn.

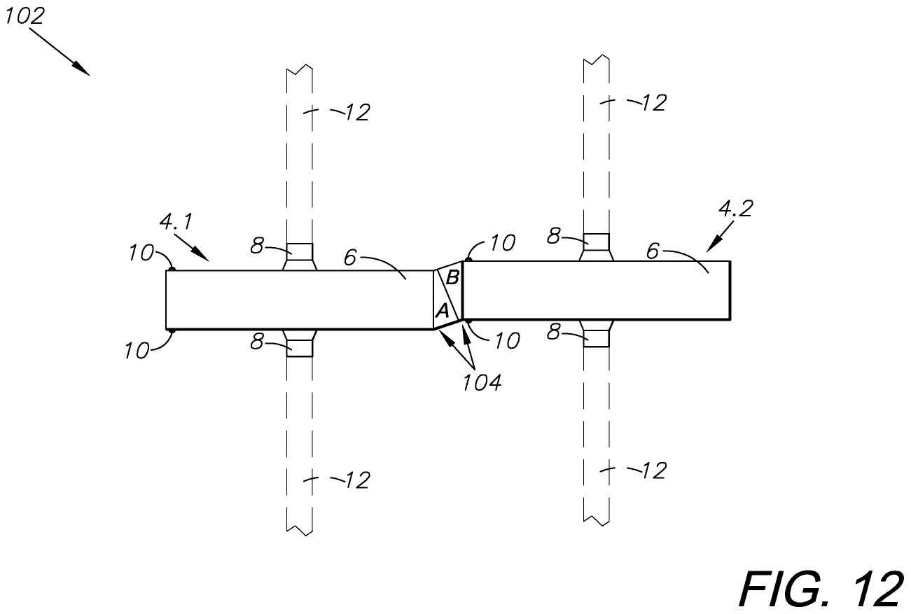

FIG. 11 similarly shows the elbow system 102, where two elbows 104 A and B, are forming a 45-degree angle. FIG. 12, similarly, has two elbows 104 A and B forming an offset, such as when it is necessary to avoid an object.

It is to be understood that while certain embodiments and/or aspects of the invention have been shown and described, the invention is not limited thereto and encompasses various other embodiments and aspects.

1. A heating, ventilation, and air-conditioning (HVAC) duct elbow system comprising:
an elbow comprising a body having a top face, a bottom face, a first wall, and a second wall;
said top face, bottom face, first wall, and second wall forming a hollow structure having a first face and a second face;
said first face having a first height and a first width, said first height defined by first edges of said first wall and said second wall, and said first width defined by first edges of said top face and said bottom face;
said second face having a second height and a second width, said second height defined by second edges of said first wall and said second wall, and said second width defined by first edges of said top face and said bottom face;
wherein said first height is not equal to said second height, and wherein said first width is not equal to said second width; and
wherein said elbow forms a bend twenty-two and a half degrees) (22.5°).

2. The system of claim 1, further comprising:
a first said elbow and a second said elbow connected such that said second face of the first said elbow faces said second face of the second said elbow; and
wherein the first said elbow and the second said elbow form a bend of forty-five degrees (45°).

3. The system of claim 1, further comprising:
a first said elbow, a second said elbow, a third said elbow, and a fourth said elbow;
said second face of the first said elbow faces said second face of the second said elbow;
said first face of the second said elbow faces said first face of the third said elbow;
said second face of the third said elbow faces said second face of the fourth said elbow;
and wherein the first said elbow, the second said elbow, the third said elbow, and the fourth said elbow form a bend of ninety degrees (90°).

4. The system of claim 1, further comprising:
a first said elbow and a second said elbow connected such that said second face of the first said elbow faces said second face of the second said elbow; and
wherein the first said elbow and the second said elbow form an offset within a duct network.

5. A method of forming a joint in a duct network, the method comprising the steps:
providing an elbow, said elbow comprising a top face, a bottom face, a first wall, and a second wall;
wherein said top face, bottom face, first wall, and second wall forming a hollow structure having a first face and a second face;
wherein said first face having a first height and a first width, said first height defined by first edges of said first wall and said second wall, and said first width defined by first edges of said top face and said bottom face;
wherein said second face having a second height and a second width, said second height defined by second edges of said first wall and said second wall, and said second width defined by first edges of said top face and said bottom face;
wherein said first height is not equal to said second height, and wherein said first width is not equal to said second width;
wherein said elbow forms a bend twenty-two and a half degrees) (22.5°); and
connecting said first face of said elbow to a piece of duct work.

6. The method of claim 5, further comprising:
wherein said elbow comprises a first said elbow;
providing a second said elbow;
connecting said second face of the first elbow to said second face of said first elbow;
and;
connecting said first face of the second elbow to a second piece of duct work. wherein the first elbow and the second elbow form a forty-five-degree) (45°) bend.

7. The method of claim 5, further comprising:
wherein said elbow comprises a first said elbow;
providing a second said elbow;
providing a third said elbow;
providing a fourth said elbow;
connecting said second face of the first said elbow to said second face of the first said elbow;
connecting said first face of the second said elbow to said first face of the third said elbow;
connecting said second face of the third said elbow to said second face of the fourth said elbow;
connecting said first face of the fourth said elbow to a second piece of duct work; and
wherein the first elbow and the second elbow form a ninety-degree (90) bend.

8. The method of claim 5, further comprising:
wherein said elbow comprises a first said elbow;
providing a second said elbow;
connecting said second face of the first elbow to said second face of said first elbow;
and;
connecting said first face of the second elbow to a second piece of duct work. wherein the first elbow and the second elbow form an offset.

9. A heating, ventilation, and air-conditioning (HVAC) duct system comprising:
a unitary duct element comprising a uniform width, a uniform height, and a uniform length;
said unitary duct element comprising at least one takeoff;
each of said takeoffs configured for connecting air supply ducts to diffusers configured for providing conditioned air into a space;
at least one elbow comprising a body having a top face, a bottom face, a first wall, and a second wall;
said top face, bottom face, first wall, and second wall forming a hollow structure having a first face and a second face;
said first face having a first height and a first width, said first height defined by first edges of said first wall and said second wall, and said first width defined by first edges of said top face and said bottom face;
said second face having a second height and a second width, said second height defined by second edges of said first wall and said second wall, and said second width defined by first edges of said top face and said bottom face;
wherein said first height is not equal to said second height, and wherein said first width is not equal to said second width;
wherein said elbow forms a bend twenty-two and a half degrees (22.5°);
the first face of said elbow connected with said unitary duct element; and
said second face of said elbow connected to a piece of duct.

10. The system of claim 9, wherein said unitary duct element, said at least one elbow, and said piece of duct form a joint selected from the list comprising: a ninety- degree (90°) bend; a forty-five) (45°) degree bend; and an offset.
